(19) United States
(12) Patent Application Publication
(10) Pub. No.: US 2004/0190430 A1
(43) Pub. Date: Sep. 30, 2004

(54) DISK EXTRACTOR APPARATUS AND METHOD

(75) Inventors: Carlo Smith, San Diego, CA (US); Les Kollegian, San Diego, CA (US)

Correspondence Address: DALINA LAW GROUP, P.C., 7910 IVANHOE AVE. #325, LA JOLLA, CA, 92037, US

(73) Assignee: DISCDEALER INC., San Diego, CA (US)

(21) Appl. No.: 10/709,086

(22) Filed: Apr. 13, 2004

Related U.S. Application Data
(63) Continuation-in-part of application No. 29/169,480, filed on Oct. 21, 2002.
(63) Continuation-in-part of application No. 10/292,269, filed on Nov. 11, 2002.
(63) Continuation-in-part of application No. 10/605,072, filed on Sep. 5, 2003.

(51) Int. Cl. G11B 7/00

(52) U.S. Cl. 369/275.1

(57) ABSTRACT

Embodiments of the invention store compact disks, allow for easy access to unformatted disks without use of two hands and without removing the top portion of the bundle package. In addition, embodiments of the invention also allow for external storage of disks and writing implements outside of the bundle package. This is accomplished via embodiments of the invention optionally comprise an extractor, external disk grooves and indentations for writing implements. After extracting a disk from the bundle package either with a finger or with an extractor, the disk may then be annotated and/or burned and placed in the grooves on the top or bottom of the bundle package. Embodiments of the invention that are configured with disk and/or implement holding grooves on the top of the burn bundle may be operated without turning the burn bundle upside down. Embodiments of the invention configured with disk grooves on the bundle base and with an extraction slot in the bundle cover may be flipped upside down in order to operate.

This application is a continuation in part of U.S. patent application Ser. No. 29/169,480, filed Oct. 21, 2002 entitled “Holder for Compact Discs” the specification of which is incorporated herein by reference. This application is also a continuation in part of U.S. patent application Ser. No. 10/292,269, filed Nov. 11, 2002 entitled, “Apparatus for Holding Disks” the specification of which is incorporated herein by reference. This application is also a continuation in part of U.S. patent application Ser. No. 10/605,072, filed Sep. 5, 2003 entitled, “Multi-Step Storage Apparatus for Adaptably Holding Discs and Disc Storage Devices” the specification of which is incorporated herein by reference.

### BACKGROUND OF INVENTION

1. Field of the Invention

Embodiments of the invention described herein pertain to the field of special packages. More particularly, these embodiments enable the retrieval of a compact disk from a disk bundle package.

2. Description of the Related Art

Unformatted compact discs may be purchased in bundle packages. The bundle packages do not allow easy access to the compact disks contained therein. Before an unformatted compact disk can be accessed, the top of the bundle package must be removed. The top of the bundle package is also known as the bundle cover. The bottom of the bundle package is also known as the bundle base. The removal of the bundle cover is generally performed using two hands, one for twisting the bundle cover and one for stabilizing the bundle base in order to keep the package from slipping on the surface upon which it is located.

In addition, after the compact disk is accessed it is generally placed in a computer compact disk tray, formatted and loaded with information. Loading a compact disk with information is also known as “burning” a compact disk.

After the compact disk has been loaded with information, the disk is removed from the tray and generally either written on or further notated with a disk label in order to specify the information contained therein. Existing bundle packages possess no means by which the disk can be further stored besides back inside the bundle package. These packages are monolithic in nature since their sole purpose to date has been to provide a single storage function without regard to other steps in the process of burning compact disks such as notating and further storing the disks.

### SUMMARY OF INVENTION

Embodiments of the invention store compact disks, allow for easy access to unformatted disks without use of two hands and without removing the top portion, i.e., the bundle cover of the bundle package. In addition, embodiments of the invention also allow for external storage of disks and writing implements outside of the bundle package. This is accomplished via embodiments of the invention that comprise at least one extraction slot, external disk grooves and indentations for writing implements.

Embodiments of the invention comprise an extraction slot that may or may not couple with an extractor. In order to operate one embodiment of the invention configured with an extractor, the extractor is depressed inward in order to grasp an unformatted compact disk. The extractor is then pulled and removes an unformatted compact disk from the bundle package. Another embodiment of the invention is actuated by pulling without depressing the extractor inward first. The extractor can be built into the bundle cover or bundle base.

Another embodiment of the invention with an extraction slot but without an extractor allows for the removal of compact disks without removing the bundle cover by inserting a finger into the bundle base housed extraction slot in order to extract a compact disk off of a shelf that a portion of the compact disk rests on in order to allow the compact disk to be removed from the bundle base.

Another embodiment of the invention with an extraction slot but without an extractor allows for the removal of compact disks by turning the bundle package upside down and inserting a finger into the bundle cover housed extraction slot in order to extract a compact disk off of a shelf that a portion of the compact disk rests on in order to allow the compact disk to be removed from the bundle cover.

The disk may then be annotated and/or burned and placed in the grooves that may be configured into the top or bottom of the bundle cover and/or bundle base. The disk may be burned before or after being annotated or placed in the grooves on the top or bottom of the bundle package. Embodiments of the invention that are configured with disk and/or implement holding grooves on the top of the burn bundle may be operated without turning the burn bundle upside down when the extraction slot is configured into the bundle base. Embodiments of the invention that are configured with disk and/or implement holding grooves on the bottom of the burn bundle base may be operated by turning the burn bundle upside down and extracting a disk from the extraction slot in the bundle cover. Another embodiment of the invention comprises extraction slots in the bundle cover and bundle base and another embodiment of the invention comprises a bundle package that is one unit which is enclosed and in this embodiment the extraction slot may reside in the top, middle or bottom portion of the monolithic bundle package or in any position there along.

Compact disk as used within this specification means any disk that contains data such as, but not limited to compact disks, compact discs, DVDs, audio disks, mini-disks and non-circular disks based on compact disk technology or any other data storing technology.

### BRIEF DESCRIPTION OF DRAWINGS

FIG. 1A is a perspective view of an embodiment of the invention configured with an extractor in the bundle base.

FIG. 1B is an exploded view of an embodiment of the invention configured with an extractor configured into the bundle base.

FIG. 1C is a top view of an embodiment of the invention configured with an extractor configured into the bundle base.

FIG. 1D is a top view of an embodiment of the invention configured with an extractor configured into the bundle base and with grooves and indentations built into the top of the bundle cover for holding writing implements and disks.

FIG. 1E is a side view of an embodiment of the invention configured with an extractor configured into the bundle base.

FIG. 2A is a perspective view of an embodiment of the bundle package configured with an extraction slot without an extractor.

FIG. 2B is an exploded view of an embodiment of the bundle package configured with an extraction slot without an extractor.

FIG. 2C is a front view of an embodiment of the bundle package configured with an extraction slot without an extractor.

FIG. 2D is a perspective view of an embodiment of the bundle base configured with an extraction slot without an extractor.

FIG. 2E is a front view of an embodiment of the bundle base configured with an extraction slot without an extractor.

FIG. 2F is a top view of an embodiment of the bundle base configured with an extraction slot without an extractor.

FIG. 2G is an exploded view of an embodiment of the bundle package configured with an extraction slot in the bundle base and with disk grooves and writing implement grooves in the bundle cover without an extractor.

FIG. 3A is a perspective view of an embodiment of the bundle package configured with an extraction slot configured in the bundle cover without an extractor.

FIG. 3B is an exploded view of an embodiment of the bundle package configured with an extraction slot configured in the bundle cover without an extractor.

FIG. 3C is a perspective view of an embodiment of the bundle cover configured with an extraction slot without an extractor.

FIG. 3D is a cutaway view of an embodiment of the bundle package configured with an extraction slot configured in the bundle cover without an extractor.

FIG. 3E is a perspective bottom view of an embodiment of the bundle cover configured with an extraction slot without an extractor.

FIG. 3F is an exploded bottom view of an embodiment of the bundle package configured with an extraction slot in the bundle cover and with disk grooves and writing implement grooves in the bundle base without an extractor.

FIG. 4A is a perspective view of an embodiment of the bundle cover configured with an extraction slot without an extractor.

FIG. 4B is an exploded view of an embodiment of the bundle package configured with an extraction slot configured in the bundle cover without an extractor showing a pull-off tab removed exposing the finger hole.

FIG. 4C is an exploded view of an embodiment of the bundle package configured with an extraction slot configured in the bundle cover without an extractor showing a pull-off tab removed exposing the finger hole.

FIG. 4D is a bottom view of an embodiment of the bundle cover configured with an extraction slot without an extractor.

FIG. 4E is a cutaway side view of an embodiment of the bundle cover configured with an extraction slot without an extractor.

FIG. 5A is a perspective view of an embodiment of the bundle cover attachment or inverted bundle base.

FIG. 5B is a cutaway view of an embodiment of the bundle cover attachment or inverted bundle base.

FIG. 5C is a cutaway view of an embodiment of the bundle cover attachment or inverted bundle base comprising various disk grooves.

FIG. 5D is a side view of an embodiment of the bundle cover attachment or inverted bundle base.

FIG. 5E is a top view of the bundle cover attachment or inverted bundle base.

FIG. 5F is a bottom view of the bundle cover attachment or inverted bundle base.

### DETAILED DESCRIPTION

In the following description, numerous specific details are set forth to provide a more thorough description of the invention. It will be apparent, however, to artisans of ordinary skill in the relevant field of expertise, that embodiments of the invention may be practiced without these specific details. In other instances, well known features have not been described in detail so as not to obscure the invention. The claims, however, and the full scope of any equivalents are what define the metes and bounds of the invention.

Embodiments of the invention store compact disks, allow for easy access to unformatted disks without use of two hands and without removing the bundle cover. In addition, embodiments of the invention also allow for external storage of disks and writing implements outside of the bundle. This is accomplished via embodiments of the invention that contain an extraction slot with optional extractor, external disk grooves and indentations for writing implements.

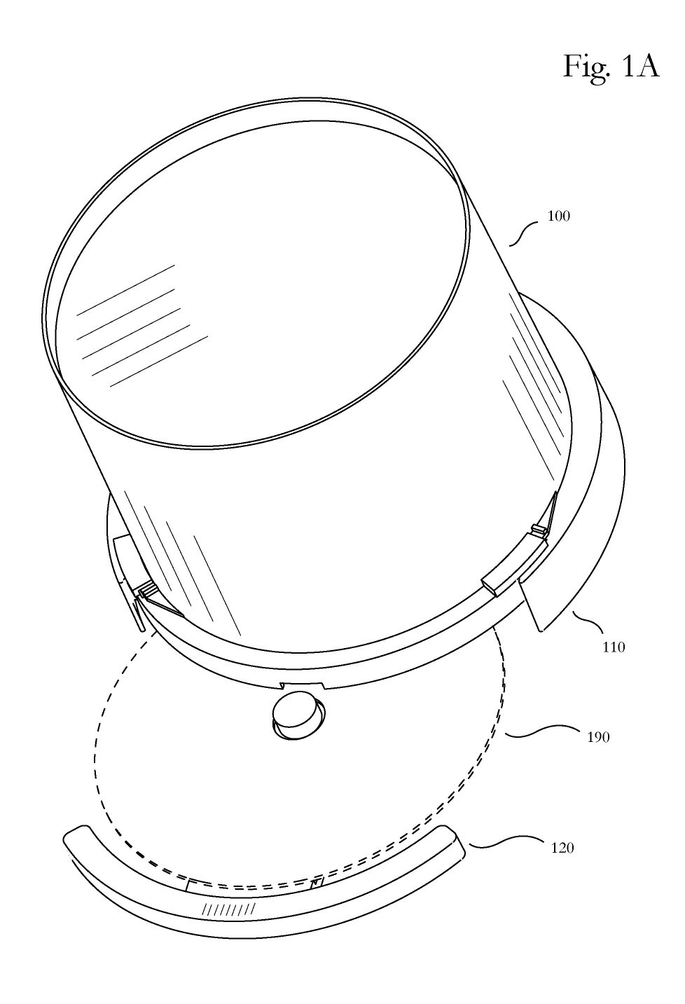

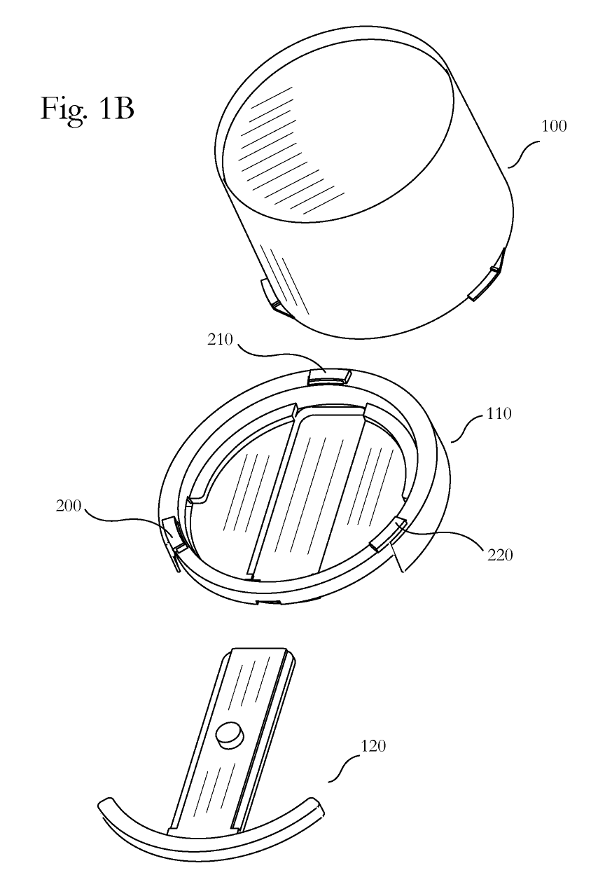

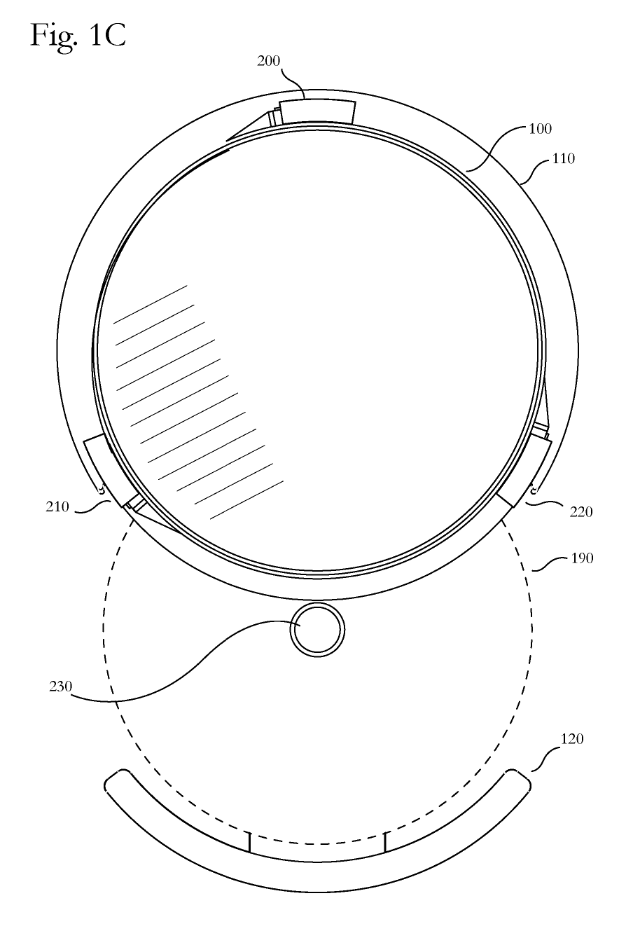

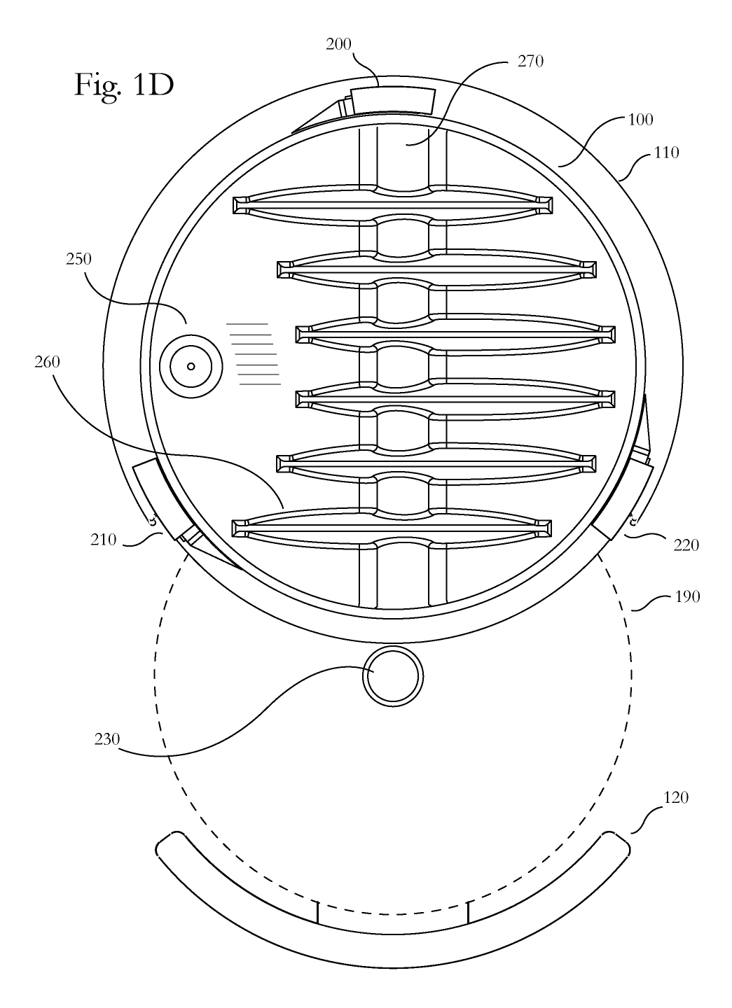

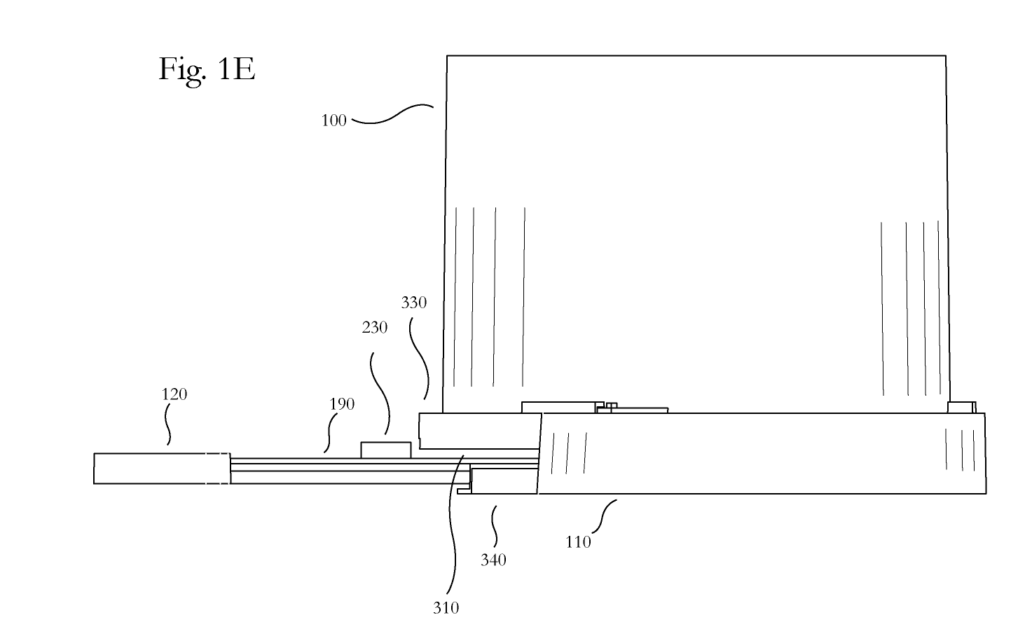

FIG. 1A shows an embodiment of the bundle package. In order to operate one embodiment of the invention, extractor 120 is depressed inward toward the center of the bundle in order to grasp an unformatted compact disk. In another embodiment of the invention, extractor 120 is pulled outward without depressing extractor 120 inward. When extractor 120 is pulled away from bundle base 110 a disk is removed from the bundle package via extraction slot 310 (see FIG. 1E).

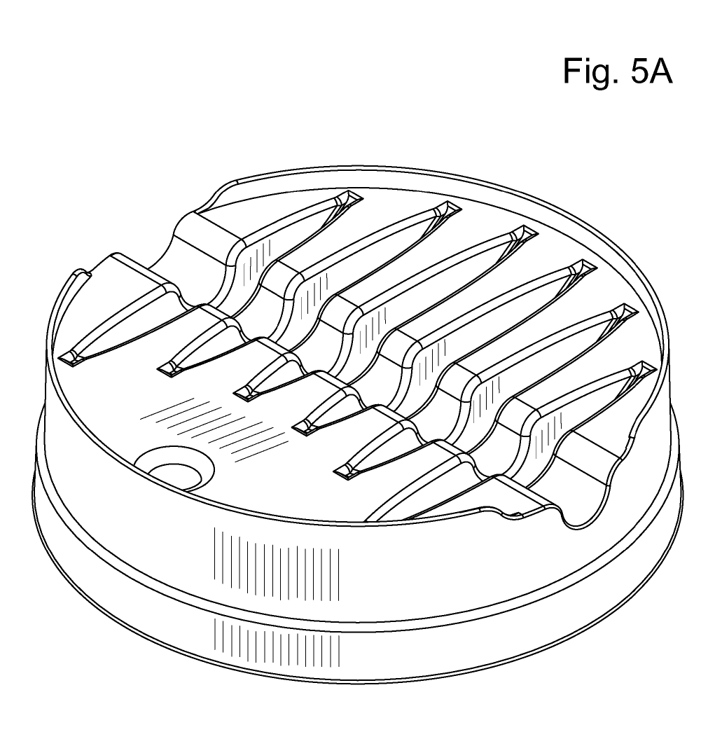

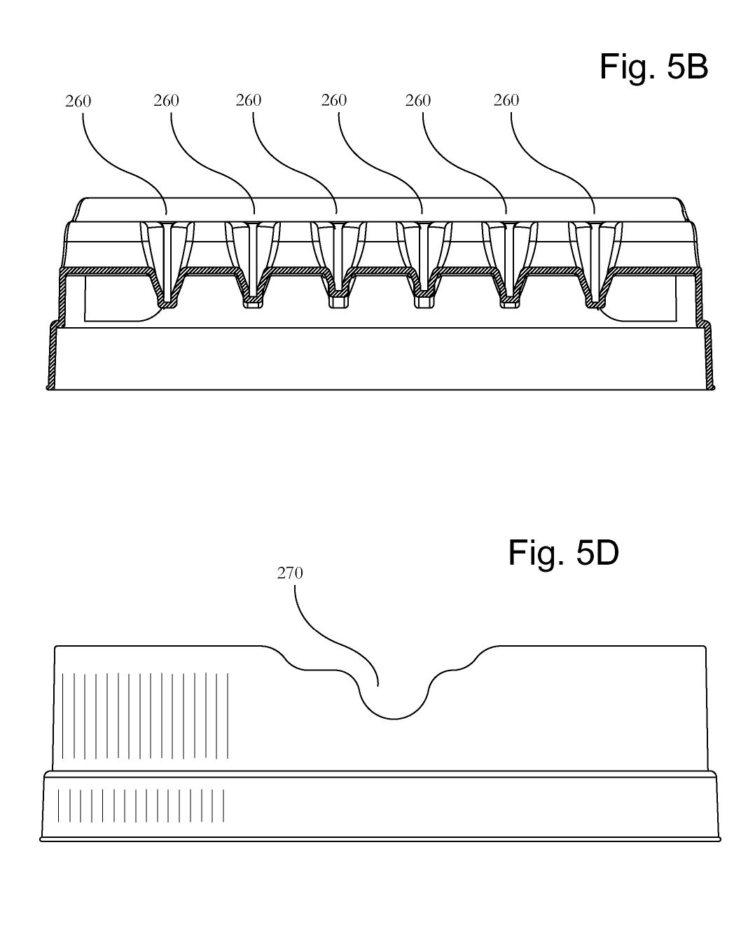

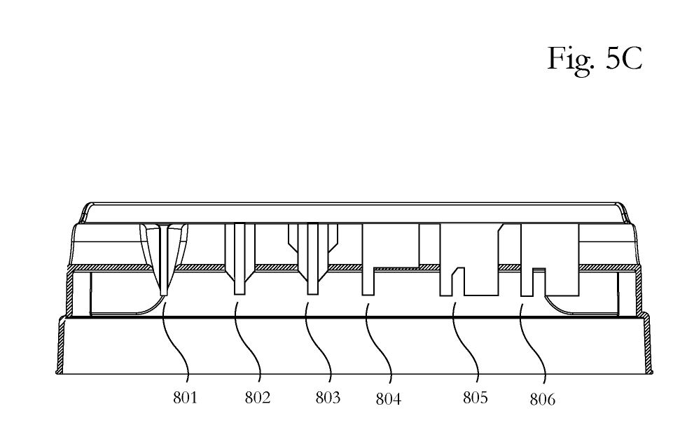

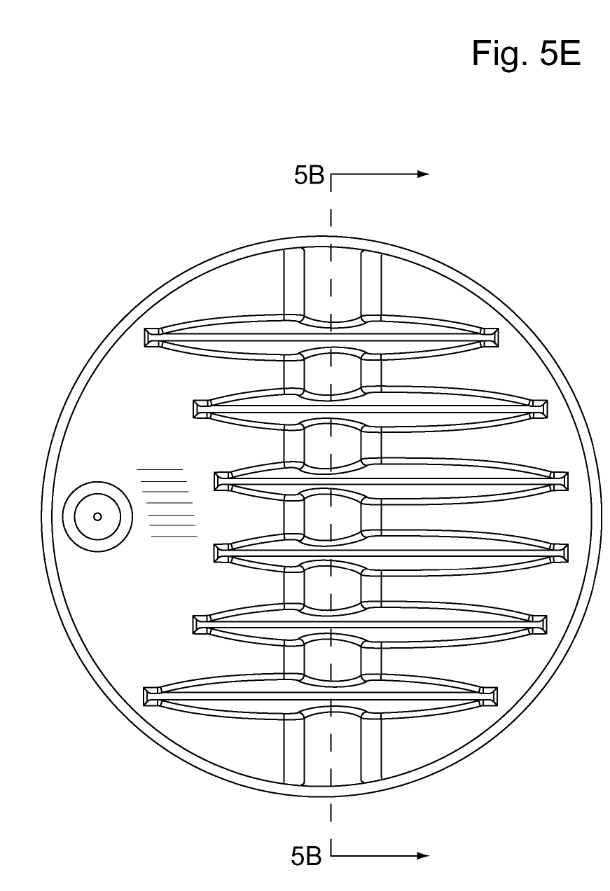

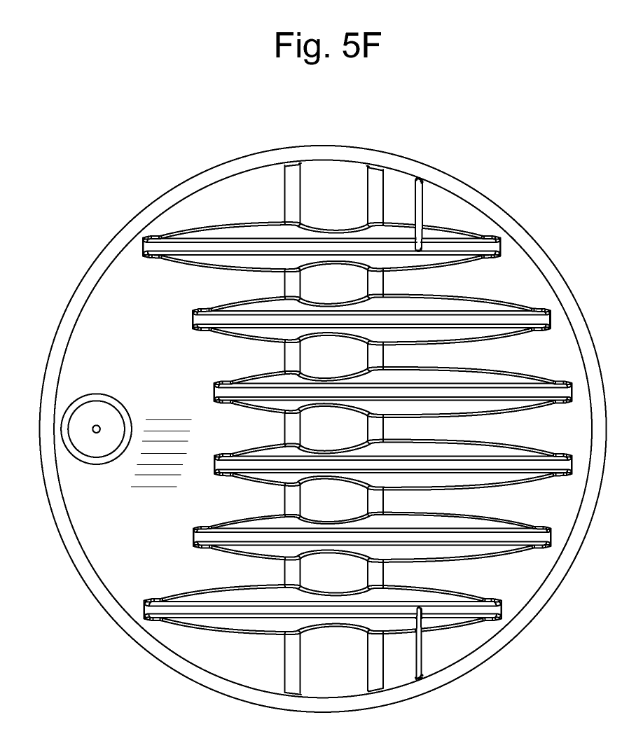

After disk removal, the disk may then be annotated and/or burned and placed in grooves on the top of the bundle package in embodiments of the invention which comprise disk holding grooves 260 and/or writing implement holding areas 250 and 270. (See FIGS. 1D, 2G and 3F). After extractor 120 is returned to the bundle base 110 another disk may be removed until bundle cover 100 comprises no further disks. FIG. 5C shows an embodiment of the invention utilizing various types of grooves for storing a disk, a slim case, jewel case, DVD case or any combination thereof. The specifics of the grooves will be described later in this document.

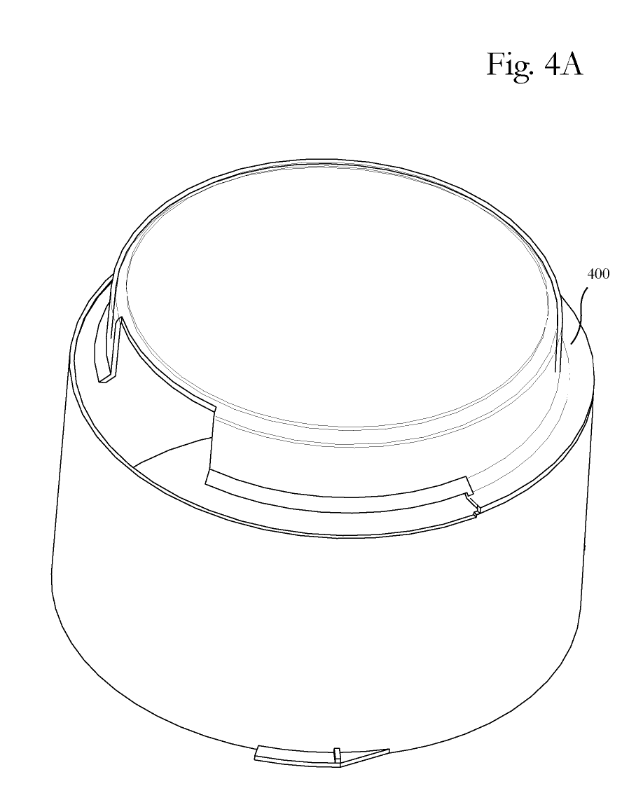

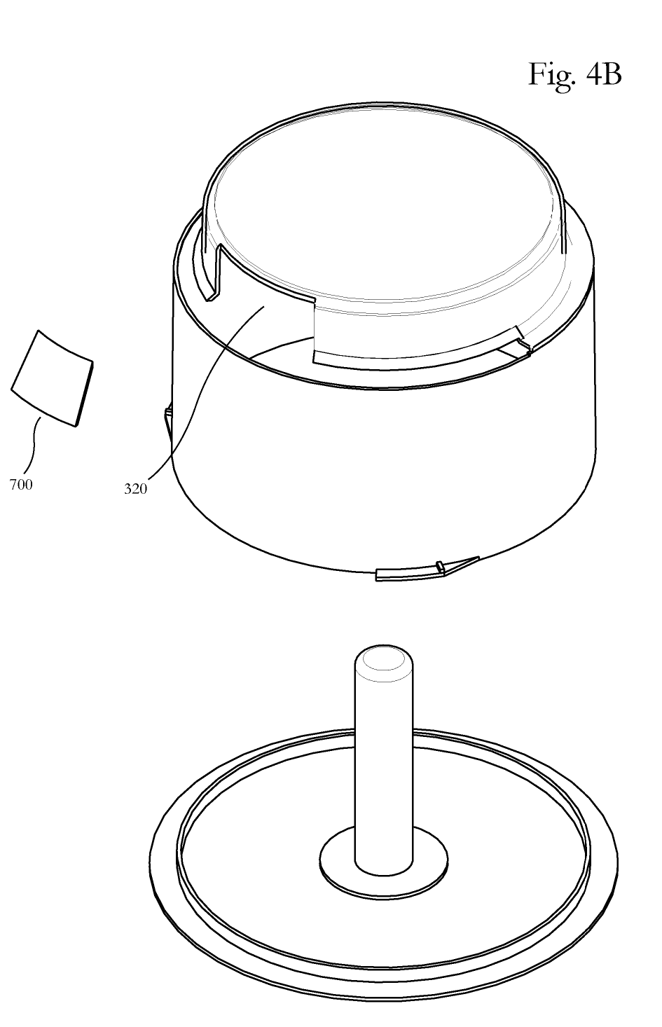

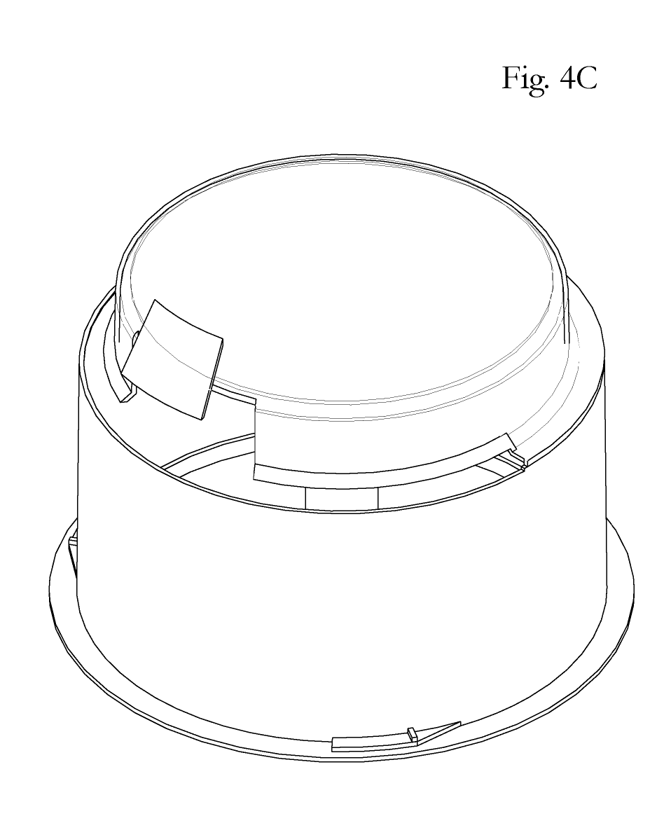

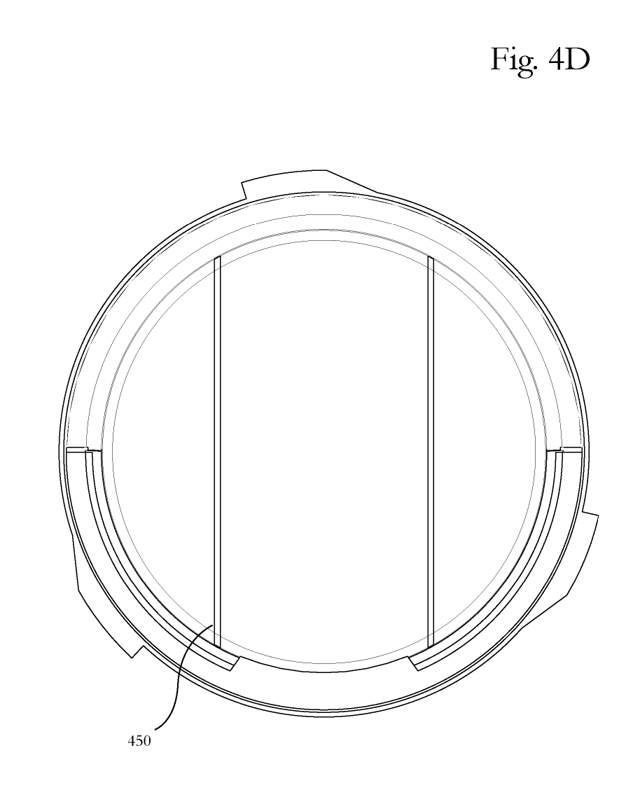

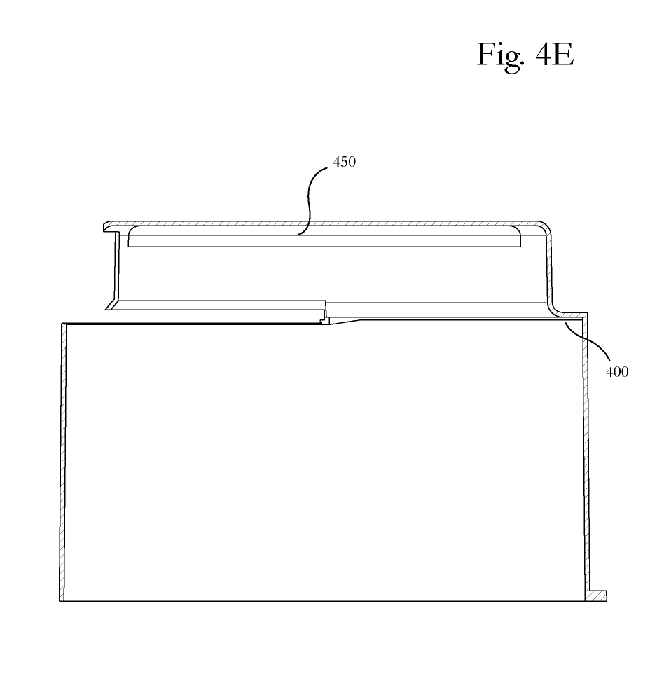

FIG. 1B is an exploded view of an embodiment of the invention configured with extractor 120 configured into bundle base 110. Flanges 200, 210 and 220 retain bundle cover 100 on bundle base 110. Rotating bundle cover 100 allows for removal of bundle cover 100 from bundle base 110. Extraction of disk 190 (shown in phantom in FIG. 1A) is performed by pulling extractor 120 away from bundle base 110 (down on the written page). Extractor 120 may possess any type of retaining mechanism in order to stop extractor 120 from being removed from bundle base 110 during normal operation. Extractor 120 may be any shape that allows for disks to be removed from bundle cover 100 via bundle base 110. An embodiment of the invention utilizing a bar shaped extractor with a rounded face is shown in FIG. 4, however any other shape may be utilized to provide a different ornamental design.

Key 230 in FIG. 1C fits into the hole in disk 190 and allows for extraction. Other embodiments of the invention may utilize suction cups, rear mounted flanges on extractor 120 or any other method for providing the force required to overcome the downward pressure of disks held inside bundle cover 100 thereby requiring effort to overcome the coefficient of static and dynamic friction between the surface of disk 190 being extracted and the disk immediately above and contacting the disk to be removed in bundle cover 100.

FIG. 1D is a top view of an embodiment of the invention configured with an extractor configured into the bundle base and with grooves and indentations built into the top of bundle cover 100 for holding writing implements and disks. Horizontal implement indentation 270 allows for writing or other implements to lay on the surface of bundle cover 100 horizontally, for example during shipping. The implements may also be inserted vertically into the bundle in vertical implement indentation 250. With an implement vertically inserted into vertical implement indentation 250, disks may be inserted into disk grooves 260, and the embodiment shown comprises six disk grooves 260 with a reference character pointing out only one disk groove 260 for brevity. More or less disk grooves may be utilized in other embodiments of the invention. Disks may be vertically inserted into disk grooves 260 before or after annotation or burning. FIGS. 5B, 5C and 5D show side views of an embodiment of bundle base 110 that more specifically shows a cut-away view of disk groove variants and a side view of horizontal implement indentation 270. Note that the bundle base 100 shown in FIGS. 5B, 5C and 5D may be configured as an add-on, i.e., a bundle cover attachment that couples with a bundle cover in order to add disk holding and writing implement holding functionality for existing bundle covers.

FIG. 1E is a side view of an embodiment of the invention configured with extractor 120 in the bundle base 110. At the point where extractor 120 meets bundle base 110, bundle base 110 is configured with a gap between bundle base upper portion 330 and bundle base lower portion 340, namely extraction slot 310. The gap between upper portion 330 and lower portion 340 is thick enough to allow for a disk to be extracted by pulling extractor 120. Disk grooves 260, whether configured in bundle cover 100 or bundle base 110 are capable of holding disks, or in other embodiments, are capable of holding disks, slim cases, jewel cases, DVD cases or any combination thereof.

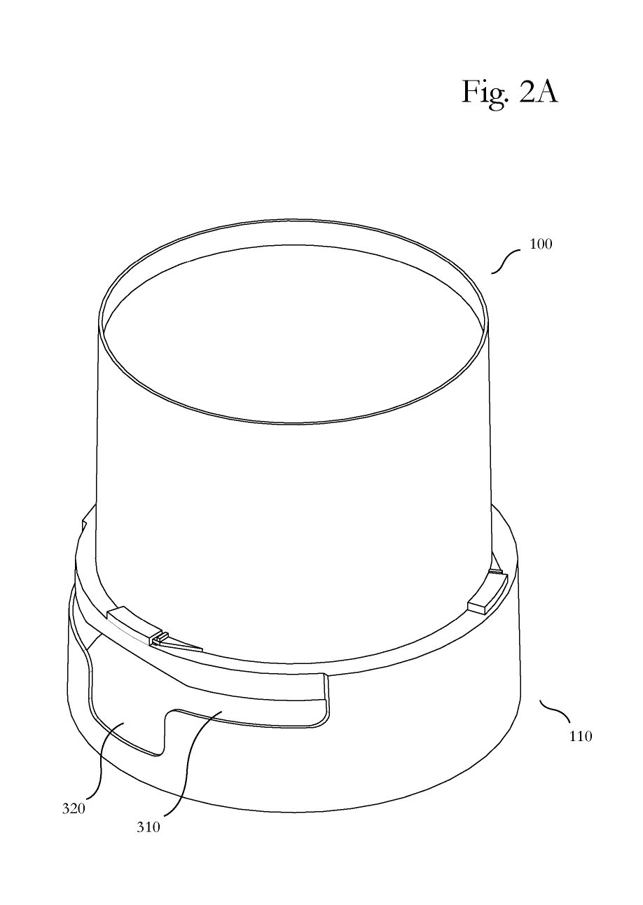

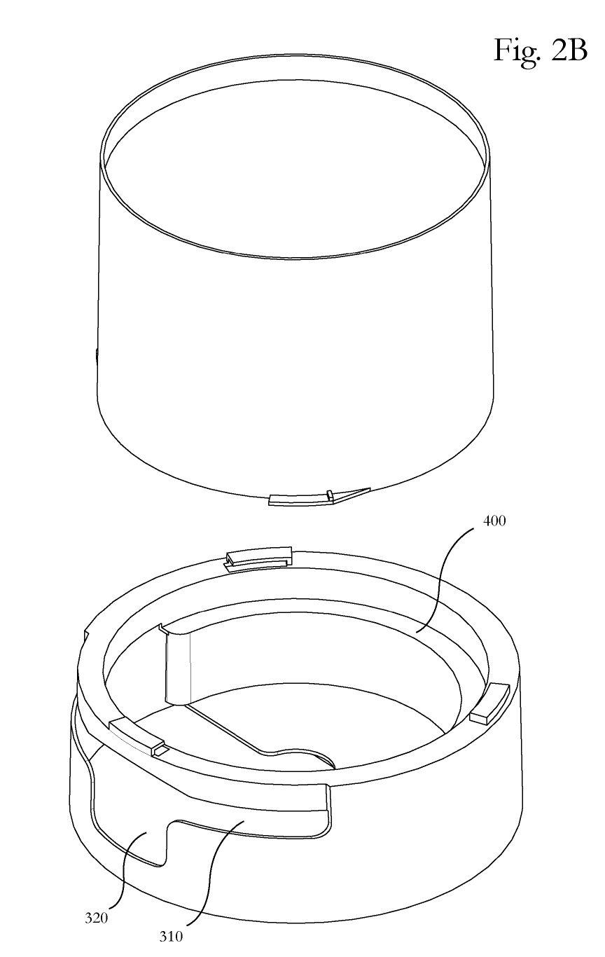

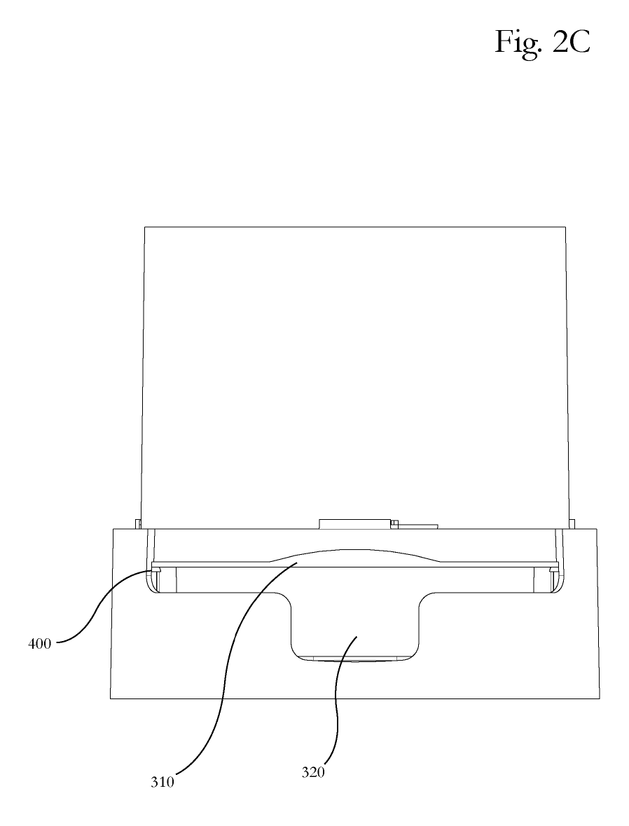

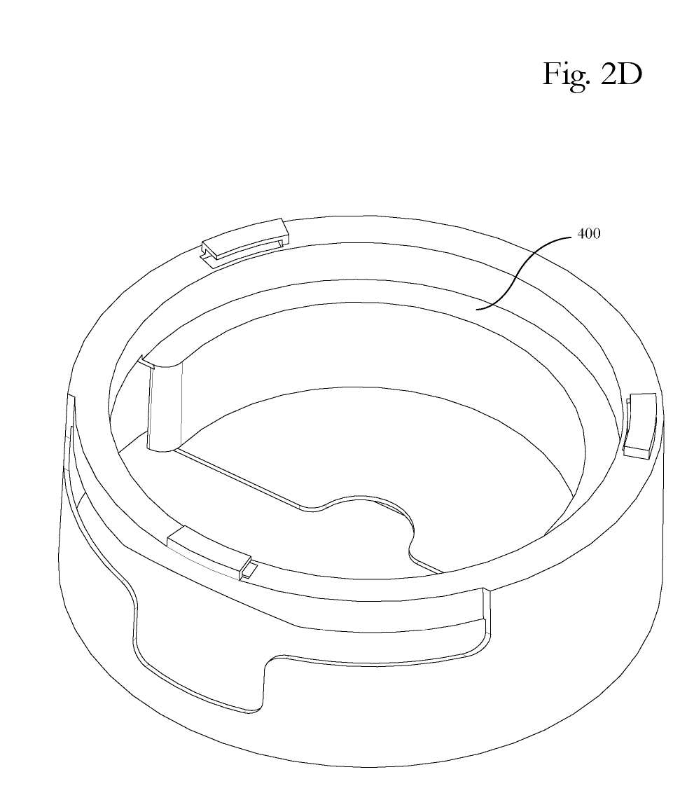

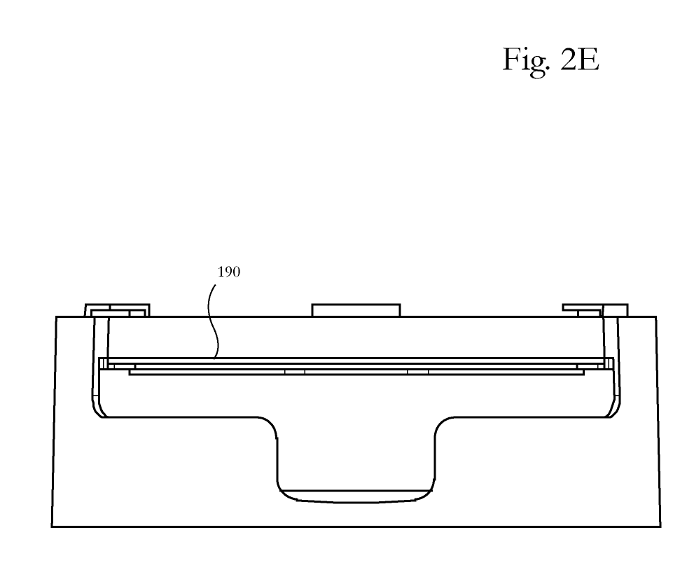

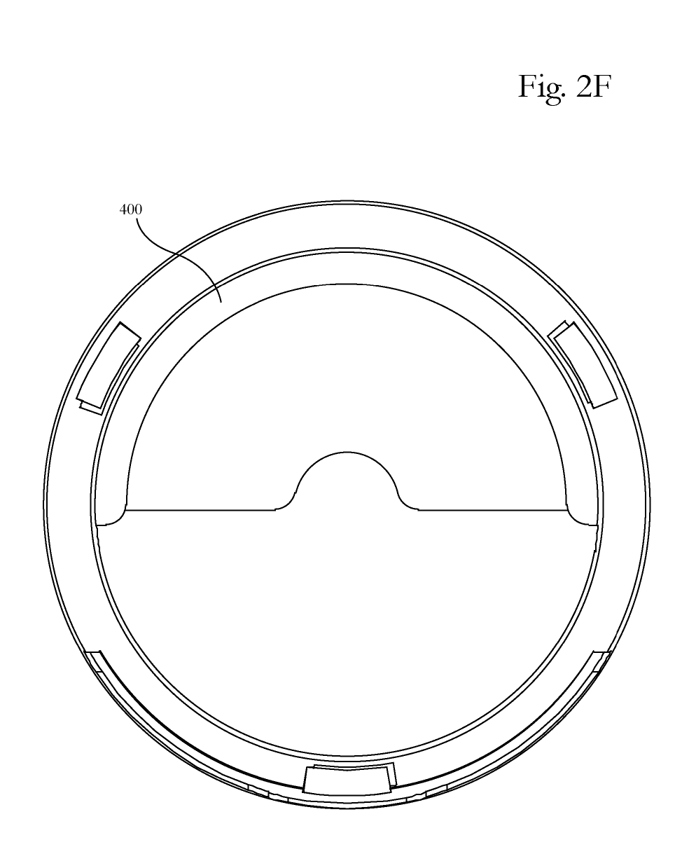

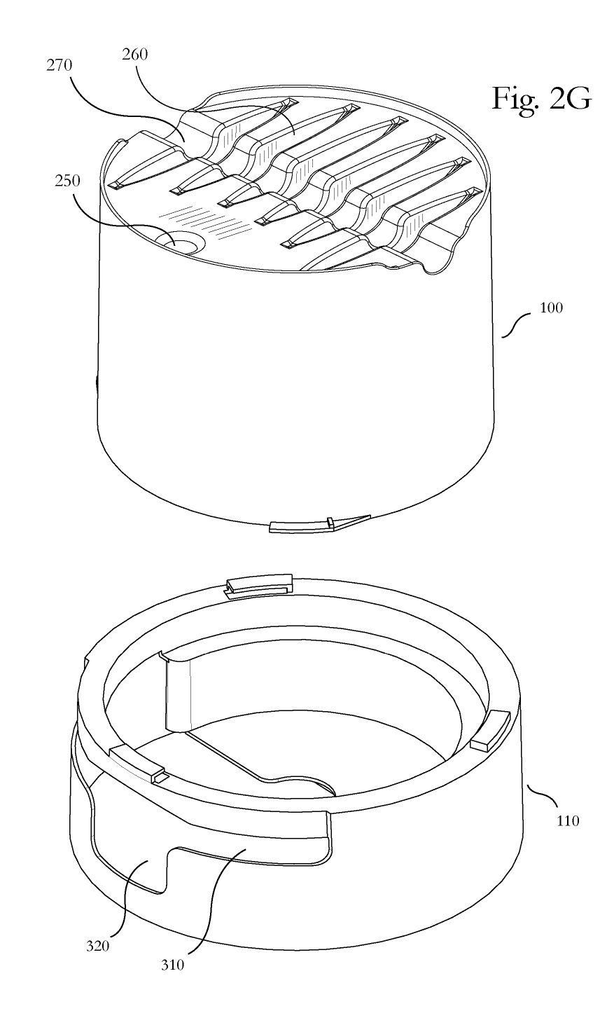

FIG. 2A is a perspective view of an embodiment of the bundle package configured with an extraction slot without an extractor. Finger hole 320 is used in order to insert a finger and pull a disk out of extractor slot 310. By pulling on a compact disk, the force required to overcome the downward pressure of disks held inside bundle cover 100, i.e., the effort to overcome the coefficient of static and dynamic friction between the surface of disk being extracted and the disk immediately above and contacting the disk to be extracted in bundle cover 100 is achieved.

FIG. 2B is an exploded view of an embodiment of the bundle package configured with an extraction slot without an extractor. Disk shelf 400 is used in order to support the outer edge of the compact disk, which may or may not include the data holding portion of the disk. When a disk is pulled slightly out of extraction slot 310, the disk no longer comes in contact with disk shelf 400 and the disk freely exits extraction slot 310. This is accomplished by inserting a finger into finger hole 320 and pulling the disk in an outwardly direction. Once the disk exits the extraction slot, another disk takes the newly removed disk's place on disk shelf 400. FIG. 2C is a front view of an embodiment of the bundle package configured with an extraction slot without an extractor. FIG. 2D is a perspective view of an embodiment of the bundle base configured with an extraction slot without an extractor. FIG. 2E is a front view of an embodiment of the bundle base configured with an extraction slot without an extractor showing the resting place of disk 190. FIG. 2F is a top view of an embodiment of the bundle base configured with an extraction slot without an extractor showing disk shelf 400.

FIG. 2G is an exploded view of an embodiment of the bundle package configured with an extraction slot in the bundle base and with disk grooves 260 and writing implement grooves 270 (horizontal) and 260 (vertical) in the bundle cover without an extractor in either the bundle cover or bundle base. Disks may be placed in disk grooves 260 in a vertical orientation before or after annotation and before or after burning. Disks may be extracted from extraction slot 310 while other disks are being held in disk grooves 260 and/or while a writing implement is in vertical implement groove 250. Note that other devices besides writing implements may be held in implement grooves 270 and 250 including razor knifes, erasers, or any other implement or tool. Note also that any type of connection methodology known may be used in order to couple bundle cover 100 to bundle base 110.

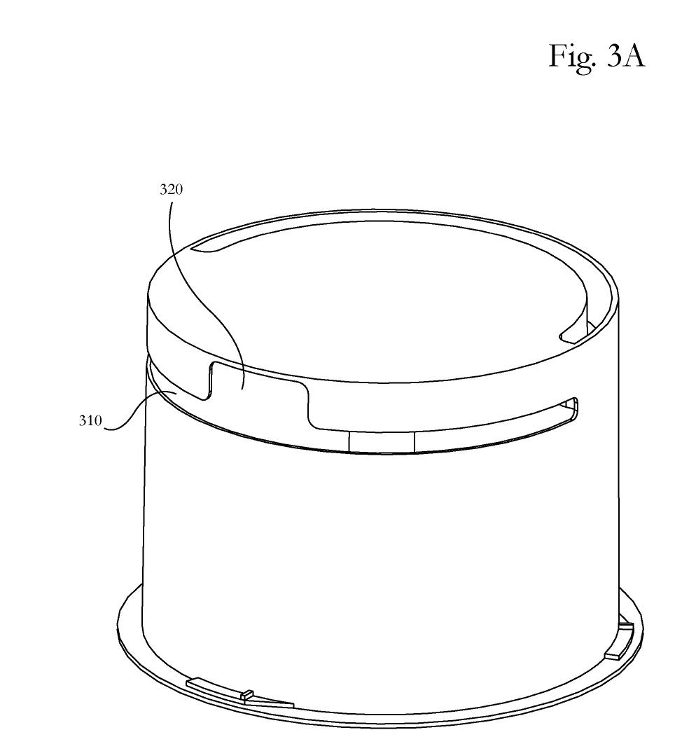

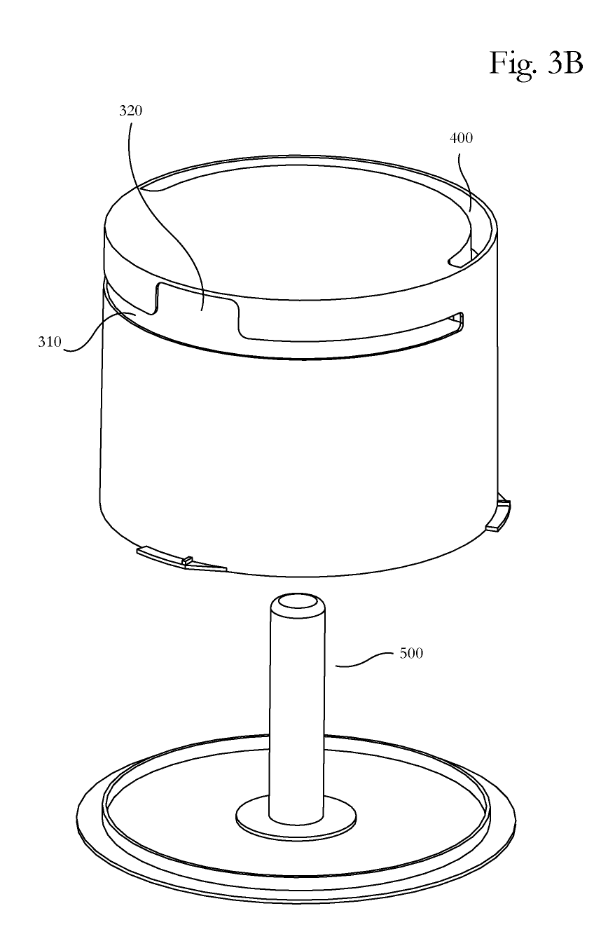

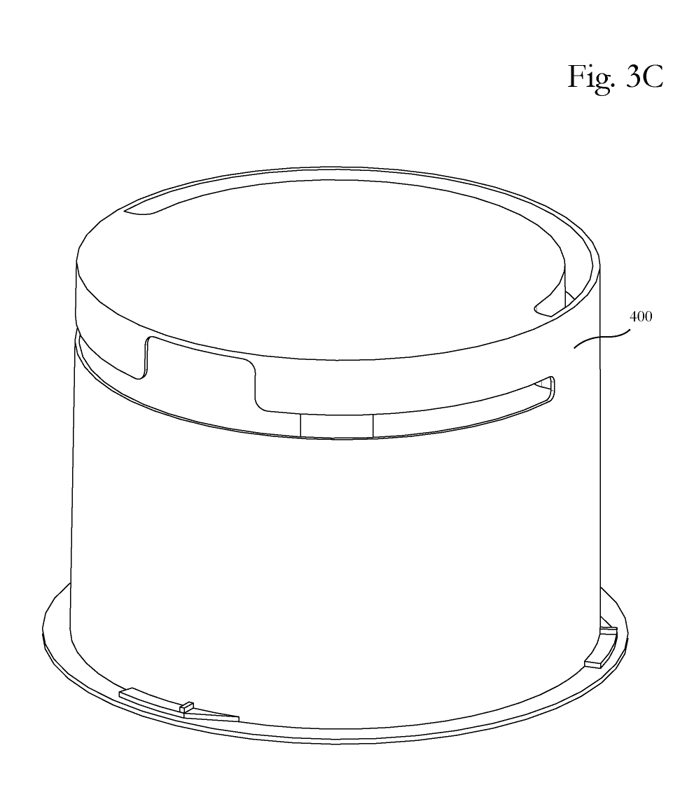

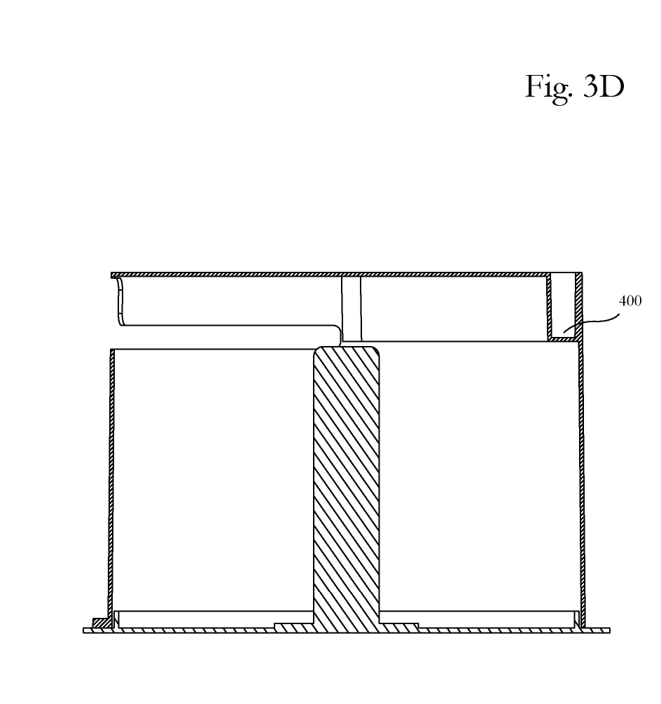

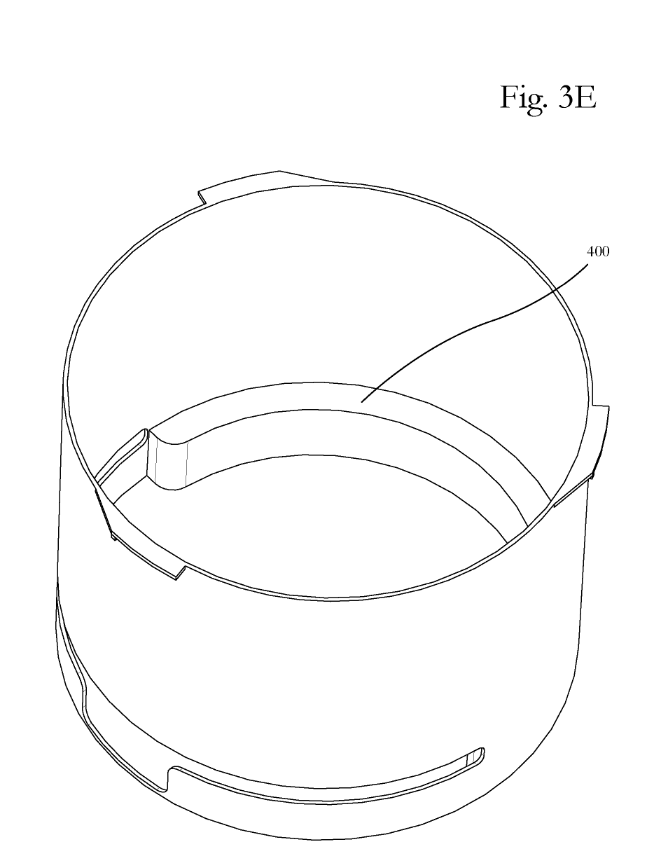

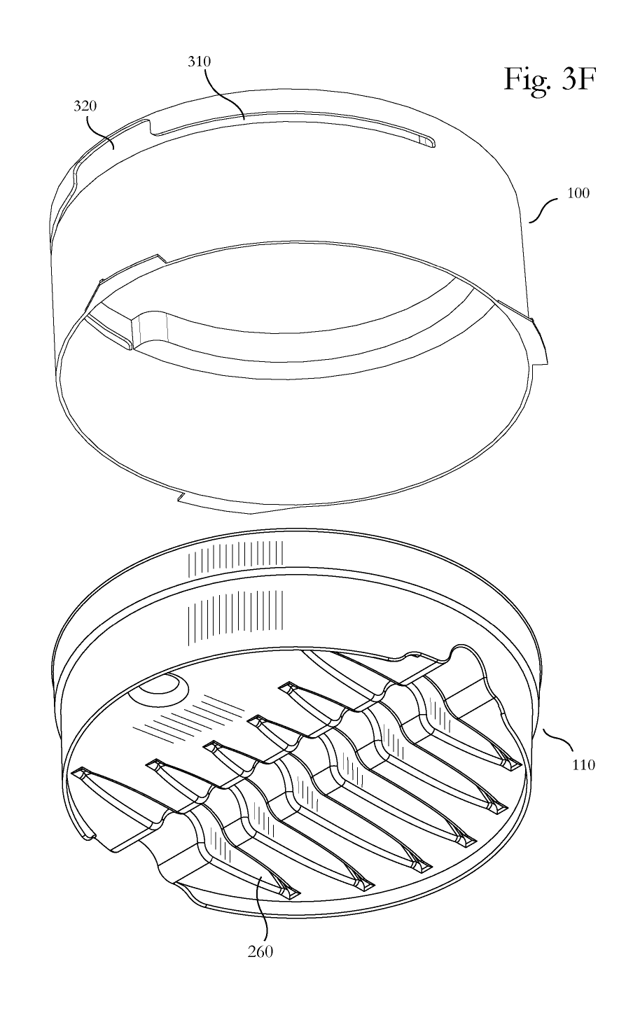

FIG. 3A is a perspective view of an embodiment of the bundle package configured with an extraction slot configured in the bundle cover without an extractor. The bundle package is generally flipped upside down which would leave finger hole 320 at the bottom of the flipped configuration. Once flipped, finger hole 320 is used in order to insert a finger and pull a disk out of extractor slot 310. By pulling on a compact disk, the force required to overcome the downward pressure of disks held inside bundle cover, i.e., the effort to overcome the coefficient of static and dynamic friction between the surface of disk being extracted and the disk immediately above and contacting the disk to be extracted in bundle cover is achieved.

FIG. 3B is an exploded view of an embodiment of the bundle package configured with an extraction slot configured in the bundle cover without an extractor. Once flipped upside down, disk shelf 400 is used in order to support the outer edge of the compact disk, which may or may not include the data holding portion of the disk. When a disk is pulled slightly out of extraction slot 310, the disk no longer comes in contact with disk shelf 400 and the disk freely exits extraction slot 310. This is accomplished by inserting a finger into finger hole 320 and pulling the disk in an outwardly direction. Once the disk exits the extraction slot, another disk takes the newly removed disk's place on disk shelf 400. Optional spindle 500 exists in some bundle packages and as long as the height of spindle 500 is lower than extraction slot 310, the disk will be capable of being removed. FIG. 3C is a perspective view of an embodiment of the bundle cover configured with an extraction slot without an extractor with internal elements shown in phantom including disk shelf 400. FIG. 3D is a cutaway view of an embodiment of the bundle package configured with an extraction slot configured in the bundle cover without an extractor. FIG. 3E is a perspective bottom view of an embodiment of the bundle cover configured with an extraction slot without an extractor; this would be the configuration as flipped where disk shelf 400 would support a disk. FIG. 3F is an exploded bottom view of an embodiment of the bundle package configured with an extraction slot in the bundle cover and with disk grooves and writing implement grooves in the bundle base without an extractor. This embodiment would be flipped upside down before extracting disks thereby leaving extraction slot 310 on the bottom and disk grooves 260 on the top.

FIG. 4A is a perspective view of an embodiment of the bundle cover configured with an extraction slot without an extractor. Disk shelf 400 is configured without an outer upright cylindrical surface as in FIG. 3A. FIG. 4B is an exploded view of an embodiment of the bundle package configured with an extraction slot configured in the bundle cover without an extractor showing pull-off tab 700 removed exposing the finger hole. The pull-off tab can be any mechanism which once removed allows for the extraction of disks from the bundle package. FIG. 4C is an exploded view of an embodiment of the bundle package configured with an extraction slot configured in the bundle cover without an extractor showing a pull-off tab removed exposing the finger hole with internal structural elements shown in phantom. FIG. 4D is a bottom view of an embodiment of the bundle cover configured with an extraction slot without an extractor, showing support 450. Support 450 may provide structural support or support for a disk being removed from the bundle package or for both. FIG. 4E is a cutaway side view of an embodiment of the bundle cover configured with an extraction slot without an extractor.

FIG. 5A is a perspective view of an embodiment of the bundle cover attachment or inverted bundle base. As a bundle cover attachment, any means of attaching the bundle cover attachment to an existing bundle cover may be used. When used as a bundle base, once flipped upside down, a bundle package would leave the bundle base exposed on top of the configuration. FIG. 5B is a cutaway view of an embodiment of the bundle cover attachment or inverted bundle base. This figure shows the sides views of disk grooves 260 which are configured to allow a disk to reside vertically oriented therein. FIG. 5C is a cutaway view of an embodiment of the bundle cover attachment or inverted bundle base comprising various disk grooves. Groove 801 allows one disk to be held. Groove 802 allows one disk or one disk case to be held wherein the disk case may be a slim disk case or jewel case. Groove 803 allows either a disk a slim disk or jewel case to be held. Groove 804 allows one disk or one disk case to be held wherein the disk case may be a slim disk case or jewel case. Groove 805 allows one disk AND one slim case, or one jewel case to be held. Groove 806 is an embodiment of groove 805 without angle guides for insertion. FIG. 5D is a side view of an embodiment of the bundle cover attachment or inverted bundle base. This figure shows implement indentation 270 for storing tools, for example during shipping. FIG. 5E is a top view of the bundle cover attachment or inverted bundle base. FIG. 5F is a bottom view of the bundle cover attachment or inverted bundle base.

Thus embodiments of the invention directed to a Disk Extractor Apparatus and Method have been exemplified to one of ordinary skill in the art. The claims, however, and the full scope of any equivalents are what define the metes and bounds of the invention.

What is claimed is:

1. An apparatus for extracting and storing disks comprising:
a bundle cover;
a bundle base adapted to couple to said bundle cover; and,
an extraction slot allowing for the extraction of a disk without removing said bundle cover.

2. The apparatus of claim 1 wherein said extraction slot is configured in said bundle cover.

3. The apparatus of claim 2 further comprising an extractor.

4. The apparatus of claim 1 wherein said extraction slot is configured in said bundle base.

5. The apparatus of claim 4 further comprising an extractor.

6. The apparatus of claim 1 wherein said bundle cover comprises at least one disk groove.

7. The apparatus of claim 1 wherein said bundle cover comprises at least one implement indentation.

8. The apparatus of claim 1 wherein said bundle base comprises at least one disk groove.

9. The apparatus of claim 1 wherein said bundle base comprises at least one implement indentation.

10. The apparatus of claim 1 further comprising a pull-off tab for opening said extraction slot.

11. A method comprising:
placing a disk in a bundle package;
engaging a bundle cover with a bundle base to form said bundle package; and,
removing said disk via an extraction slot without disengaging said bundle cover with said bundle base.

12. The method of claim 11 further comprising:
placing said disk in a disk groove coupled with said bundle package.

13. The method of claim 11 further comprising:
removing an implement from an implement indentation;
using said implement; and, returning said implement to said implement indentation.

14. The method of claim 13 further wherein using said implement comprises annotating a disk.

15. The method of claim 11 further comprising:
actuating an extractor coupled with said extraction slot.

16. An apparatus comprising:
means for placing a disk in a bundle package;
means for engaging a bundle cover with a bundle base to form said bundle package; and,
means for removing said disk via an extraction slot without disengaging said bundle cover with said bundle base.

17. The apparatus of claim 16 further comprising:
means for placing said disk in a disk groove coupled with said bundle package.

18. The apparatus of claim 16 further comprising:
means for removing an implement from an implement indentation; and,
means for returning said implement to said implement indentation.

19. The apparatus of claim 18 further wherein means for using said implement comprises means for annotating a disk.

20. The apparatus of claim 16 further comprising:
means for actuating an extractor coupled with said extraction slot.
